(19) United States
(12) Patent Application Publication
(10) Pub. No.: US 2014/0249659 A1
(43) Pub. Date: Sep. 4, 2014

(54) Method for Finding Influential Nodes in a Social Network

(71) Applicant: Patrick Kehyari, Warsaw (PL)

(72) Inventor: Patrick Kehyari, Warsaw (PL)

(21) Appl. No.: 13/784,190

(22) Filed: Mar. 4, 2013

(51) Int. Cl. G06F 17/00

(52) U.S. Cl. CPC G06F 17/60
USPC 700/91

(57) ABSTRACT

A method of identifying a pool of nodes in a social network with a much greater mean level of influence than an equal sized random sample of a target audience, includes the steps of, in association with the broadcast or display of a contest or poll, inviting members of an audience of the broadcast to cast votes, and setting a cost of, or barrier to, voting that reveals the nodes of influence.

### BACKGROUND OF THE INVENTION

1. Field of the Invention

The present invention relates to Internet-based or online social networks, and in particular to a method of locating influential nodes within social networks though the use of electronic voting or polling.

The method of the invention is carried out in association with broadcasts of a single or multi-round contest or poll, in which winners or outcomes of each round are determined by votes that are cast electronically by members of an audience of the broadcast.

The term “node” refers to an identifiable entity capable of casting votes through one or more devices and one or more physical connections to the social network. The physical connections may include any of a variety of media, and may involve the Internet and/or another communications network. The identifiable entity may, for example, be an individual member of the social network identifiable by a login name and password. As a result, those skilled in the art will appreciate that, while the term “node” requires at least one device and at least one physical connection to the network, the “node” is not required to be associated with any one particular device or physical connection.

According to the invention, “votes” on subject matter important to “social identity” are solicited from nodes associated with the network, and those nodes that respond when the cost of voting is high are identified as influential. The term “social identity” may be defined as “that part of an individual's self-concept which derives from his knowledge of his membership in a social group together with the value and emotional significance attached to the membership” (H. Tajfel, Human Groups and Social Categories, Cambridge University Press (1991), and includes such individual characteristics as musical taste, political affiliation, sports teams, sports in which the voters participate, regional home area, school, neighborhood, sexual orientation, socioeconomic background, and any other characteristics that falls within accepted definitions of “social identity,” such as Tajfel's definition. Those skilled in the art will appreciate that the foregoing listing is exemplary in nature, and that other characteristics will also fall within the definition of “social identify.” By way of example and not limitation, the subject matter characteristic of the voter's social identity may be musical taste, and the votes used to identify influential nodes may relate to a multiple-round music video competition, with the votes determining which videos move on to the next round and which are eliminated

In a preferred embodiment of the invention, the cost of voting, in terms of money, time, or difficulty, may be set to be sufficiently low so that the cost does not constitute a significant barrier to voting, thereby maximizing the number of voters. According to this embodiment, as the contest proceeds to later rounds, the cost of voting is increased. As the number of votes decreases in response to the increases in cost, the average influence or value of the nodes to marketers should increase. As a result, the nodes from which the votes are cast may be deemed to be nodes of greater influence or higher value to marketers and are identified and recorded. However, in an alternative embodiment of the invention, the cost of voting, in terms of money, time, or difficulty could be set an estimated appropriate level from the beginning and would not need to be changed over the course of the campaign in order to find nodes of greater value. In either embodiment, the nodes of greater value may be targeted by marketers, political campaigns, and others seeking to maximize the value of their solicitations.

2. Description of Related Art

a. Background—Social Identity, the Voting Paradox, and the Relationship Between Cost of Voting and Influence

In order to understand why influential nodes can be identified based on voting behavior, it helps to understand the concepts of “social identity” (which provides a motivation for persons of influence to vote) and “the voting paradox” (which explains why such motivation is necessary). Essentially, individuals are more likely to vote when the vote is on a topic related to social identity, and when the individuals feel that their votes will influence the votes of others, thereby overcoming the “voting paradox” that any one individual vote is unlikely to change the outcome of an election.

Humans have always had a need to align themselves with groups. According to Anthropologist Robin Dunbar, modern humans evolved to live in larger groups of hunter gatherers whose networks ranged in size from about 30 to 150 members. For the vast majority of the time that Homo Sapiens has walked the Earth (about 200,000 years), this didn't change, until the advent of farming settlements around 8,000 BC.

As Biologist E.O. Wilson explains in “The Social Conquest of Earth”:

“With the emergence of villages and then chiefdoms in the Neolithic period around 10,000 years ago, the nature of the networks changed dramatically. They grew in size and broke into fragments. These subgroups became overlapping and at the same time hierarchical and porous. The individual lived in a kaleidoscope of family members, coreligionists, co-workers, friends, and strangers. His social existence became far less stable than the world of the hunter-gatherers. In modern industrialized countries, networks grew to a complexity that has proved bewildering to the Paleolithic mind we inherited. Our instincts still desire the tiny, united band-networks that prevailed during the hundreds of millennia preceding the dawn of history. Our instincts remain unprepared for civilization. The trend has thrown confusion into the joining of groups, one of the most powerful human impulses. We are ruled by an urge—better, a compelling necessity—that began in our early primate ancestry. Every person is a compulsive group-seeker, hence an intensely tribal animal. He satisfies this need variously in an extended family, organized religion, ideology, ethnic group, or sports club, singly or in combination.”

Essentially, an individual's social identity defines that individual's relationships to other individuals by associating the individual with particular groups. Humans have a biological need to define themselves and their place in the social structure, and to advertise this identity to potential mates or tribal allies. For example, as explained in the paper by A. Lonsdale entitled “Musical Taste and Ingroup Favouritism,” Group Processes & Intergroup Relations, vol. 12, no. 3, pp 319-327 (May, 2009), young people in western culture often use taste in music as a badge to define themselves and their social groups. A teenager that follows heavy metal very likely has close friends that also follow heavy metal and is unlikely to have many close friends that follow hip hop, and vice versa.

Many of the same dynamics persist for older individuals, but the badges by which the older person defines himself change to reflect other priorities, such as political ideology. For example, a liberal is more likely to have liberal than conservative friends. A study by R. Huckfeldt and J. Sprague, entitled Citizens, Parties, and Social Communication (Cambridge University Press, 1995) and cited in Nicolas A. Christakis, MD, PhD and James H. Fowler, PhD, Connected, The Surprising Power of Our Social Networks and How They Shape Our Lives (2009), found that people tend to segregate themselves into like minded groups, and that most ties are between people who share the same interests, with about two out of every three friends having the same ideology.

The Christakis and Fowler study relates this finding concerning the tendency for like minded people to associate with each other to a seemingly unrelated problem, which may be referred to as the voting paradox. The voting paradox is that the chance of a single vote affecting the outcome of a political election, or any other poll or election in which large numbers of people participate, is astronomical. In fact, not a single one of the thousands of congressional, statewide, or nationwide elections that has taken place in the entire history of the United States has been decided by just one vote. Thus, there is no rational reason for any individual to vote, because the chances that the individual's vote will affect the election are worse than the chance of winning a statewide or multistate lottery. Voting entails costs, such as the cost of driving to a polling station and the time it takes to vote, and the cost, if one considers only the effect of the individual's single vote, will most likely not be justified.

So why does anyone vote when the cost/benefit ratio seems so unfavorable? According to Christakis and Fowler, it is because the decision to vote in fact increases the likelihood that others will vote, and that voters on some level understand this. In other words, the act of one person voting increases the possibility that others in that person's social circles will vote.

When Christakis and Fowler created a computer model to simulate what happens when one person decides to vote, they found that, in some cases, the act of voting by a single individual could spread like wildfire, setting off a cascade of up to one hundred other people voting, even though people typically were directly connected to only three or four other potential voters. Moreover, since those of like political persuasion tend to associate with one another, the cascades of people influenced to vote yielded substantial increases in people voting the same way.

One prediction of Christakis and Fowler's computer model is that the cascades will be largest if they emanate from someone who was in a moderately “transitive” group. The term “transitive” refers to the interrelatedness of the nodes, i.e., how many individuals in the group are related to other members of the group. For example, a voter with a transitivity of 0.5 would mean that half of the voter's friends were friends with each other. Christakis and Fowler found that the largest cascades started in moderately transitive groups. Highly transitive groups tended to only affect members within the group, i.e. the highly transitive groups are in effect cut off from the world, while too little transitivity means that the group is too disorganized or lacks the cohesiveness to reinforce its own members' behavior.

Christakis and Fowler further found that people who were the most likely to vote were having a transitivity of about 0.5. Since voting behavior is related to the transitivity of the voter, it appears that individuals somehow take into account their position in their groups when deciding whether to vote. This is likely a subconscious process since most persons are no social scientists and likely do not take into account group interrelatedness when making voting decisions. Nevertheless, according to the results described by Christakis and Fowler, voters apparently have a sense as to whether their actions are likely to affect others, i.e., of their “influence” on others and in particular to their ability to affect people beyond direct connections through a cascade effect, and take action accordingly. People whose friends do not know one another participate less, as do those in tightly knit cliques of friends. In other words, according to Christakis and Fowler, the better positioned a voter is to influence the most people, the better the voting cost/benefit ratio, and the more likely to vote.

The present invention utilizes the above-described findings, and in particular the finding that, with respect to issues that relate to social identity, the likelihood that an individual will vote depends on that individual's influence. In particular, the present invention utilizes this finding as a way to locate influential nodes in a social network. However, the fact that influence results in an increased likelihood of voting does not by itself enable persons of influence to be located, since the votes of the influential cannot easily be distinguished from the votes of the less influential, or from the votes of the influenced. Christakis and Fowler are not concerned with identifying persons of influence, and do not suggest a way to use voting patterns as a measure of individual influence that might be useful to those who wish to target the influential.

The present invention solves this problem, and therefore provides a new tool that will greatly increase the efficiency of marketing and solicitation in the digital age by enabling the objective identification of a pool of persons that has a relatively high likelihood, in comparison with a random sample, of containing individuals whose choices are most likely to affect others, and therefore who are of high value to marketers.

b. Relationship Between Theory and Application

As explained above, the inventor has taken various abstract academic findings regarding social identity and voting behavior, and used them to develop a way to predict influence based on voting behavior. In particular, the inventor has developed a specific method for identifying “nodes” of influence, based on voting behavior with respect to contests, competitions, polls, and the like that involve issues of social identity rather than, for example, contests, competitions, and polls in which the votes are based primarily on non-social identity related issues such as the talent of the contestants.

It is not apparent that observing that a person has voted can predict the person's influence, much less that votes can be arranged to reveal a voter's influence. To do so requires steps in addition to merely observing whether a person has voted. The additional steps involve not only observing a vote or poll, but also conducting the vote or poll in a way that separates the influential from the influenced. This is accomplished, according to the principles of the invention, by conducting the vote or poll in such a way as to raise the cost of voting or participation. The cost of voting or participation may be increased in stages or can be set high from the onset of the vote or poll, and can not only be monetary, but also may involve time and/or difficulty such as solving a puzzle or entering a captcha or time, such as the time it takes to register (name, e-mail. and password).

In one practical implementation, the influence-identifying method of the invention may be carried out in connection with an “Internet-based or online social network,” defined herein as an online group of people who use a D site or other technologies to communicate with each other and share information and resources. Such Internet-based or online social networks provide an ideal platform for performing the method of the invention because they provide ideal information flow so that a person of influence's behavior will reliably affect others. In addition, most online social networks allow votes or polls to be conducted in a way that facilitates the collection of data on the participants.

It will be appreciated that identifying persons of influence is not the same as the conventional use of the social network to identify persons interested in a particular product. Instead, the method of the invention seeks to identify persons of more generic influence, i.e., persons whose actions can generally affect the actions of a large number of other persons in a variety of contexts.

In summary, the inventor has discovered a way to using a contest or poll and communications by electronic or digital media to locate persons of influence, for example in a social network, by adapting research findings that show the effect of group interrelatedness on voting so as to locate persons of influence based on their participation in the contest or poll.

### SUMMARY OF THE INVENTION

It is accordingly an objective of the invention to provide a method, using electronic or digital communications, to identify persons of influence, or influential nodes, in social networks, including but not limited to Internet-based or online social networks. Examples of such networks include but are not limited to Facebook™, Twitter™, MySpace™, Linked-In™, and Google Reddit™, Digg Pinterest™, and Tumblr™, as well as special interest networks such as University Alumni networks, online fan clubs, and so forth.

The invention utilizes technology to locate the persons of influence or influential nodes, by looking not at the interrelationships between individuals (even though those interrelationships do affect influence), but rather by looking at individuals' voting behavior.

While the method of the invention can be applied to any contest created with competing issues of significance to group or social identity, in a specific exemplary embodiment of the invention, the contest to which the method of the invention is applied is a multi-round music video contest. Some examples of competing group identity that may be used in this type of contest are: rock vs. hip hop; electronic vs. pop; emo vs. rock; soul vs. pop; punk vs. emo; boy bands vs. girl bands; Europe vs. USA; Sweden vs. Poland; 80s vs. 90s; American hip hop vs. European hip hop; UK vs. Sweden; UK vs. Poland; French hip hop vs. Polish hip hop; and British rock vs. American rock.

On the other hand, it will be appreciated that while the invention may be applied to music competitions, it does not apply to every music competition, but rather applies only to contests in which the votes are affected by or involve issues of group identity. An example of a competition that would not be effective for this method is one that is framed or presented as a talent competition where the audience is asked to choose between competitors based primarily on talent without a significant focus on issues of group identity, such as American Idol™. On the other hand, an example of a similar competition where this method could be applied is the Eurovision Song Contest, were each performing act represents a different country.

The invention requires a means of enabling viewers to vote for their choices in the contest, which can take the form of an application that interacts with the voter through a social network application programming interface (API) or the like. Alternatively, voting can be carried out through SMS messages or “texts,” e-mail, instant messaging (IM), and so forth. The costs of voting, if monetary, can be established and/or raised by means such as utilizing a telephone number that allows the telephone company to collect charges for dialing the number, or having voters authorize charges on an electronic payment service used for transactions on the social network, such as a PayPal™ account.

### BRIEF DESCRIPTION OF THE DRAWINGS

FIG. 1 is a flow chart of a method for identifying influential nodes or entities in accordance with the principles of a preferred embodiment of the invention.

FIG. 2 is a schematic diagram of a system to which the method of FIG. 1 is applied.

FIGS. 3A and 3B include screenshots of a contest and vote-acquisition page for implementing the method of FIG. 1.

### DETAILED DESCRIPTION OF THE PREFERRED EMBODIMENTS

FIG. 1 shows a method for identifying influential nodes or entities in accordance with the principles of a preferred embodiment of the invention. The first step of the preferred method, step 10, is to provide persons with an invitation and a means to cast a vote in association with a broadcast contest, poll, or event about which a poll can be conducted. The broadcast may be, but is not required to be, carried out over multiple rounds or stages, in which viewers of the broadcast may cast votes that determine the outcome of each round or stage, for example by selecting which contestants in a round move to the next round and which are eliminated.

In order to obtain meaningful audience participation, the subject matter of the vote must concern a defining characteristic of group identity (the term “group identity” also refers to “social identity”) relevant to the persons in the audience, i.e., a characteristic that is of significance to a person's group identity or image and that is likely to polarize the audience to a sufficient degree that the outcome is not viewed as a foregone conclusion, such as musical taste, political affiliation, sports teams, participatory sports, ethnicity, nationality, regional home area, school, neighborhood, sexual orientation, socioeconomic backgrounds, and so forth. However, those skilled in the art will appreciate that characteristics of significance to a person's identify or image may change over time, and for different audiences, broadcast regions, and so forth, and therefore the invention is not to be limited to particular subject matter.

Step 10, and in particular provision of an initial invitation to vote (in the example of a multi-round context, in association with the first round or stage of the contest), may be implemented in a variety of ways, including broadcast of the invitation during the broadcast, and/or separate invitations by text, social media messaging, and/or web advertising through websites such as Google.com™. However, it is an essential feature of the invention that the votes be ultimately expressed in electronic form, so that they can be tabulated and the source of the votes identified. Examples of voting means include providing numbers representing choices to which SMS messages may be sent to express a vote for that choice, voting interfaces on social media such as Facebook™ and Twitter™, and direct input of votes to a webpage.

In a multiple round contest, the increase in cost can occur at any round after round one, and may involve a single increase or multiple increases in cost. This increase in cost must be made known to voters in order to utilize the influence effect discussed above, so that only voters who see greater benefit from voting, and therefore are likely to have greater influence, will cast votes. The idea is to limit the number of voters, so the increase in cost must be sufficient to have this effect. The use of multi-round or multi-stage contest is preferred because it in effect establishes a baseline from which to separate those who vote based on their influence and those who are influenced.

However, it is possible that this could be achieved in connection with a single round contest, so long as the cost is enough to exclude a significant number of the target audience members whose understanding of their lesser influence causes them not to vote, so that those who actually vote are persons of greater influence. There is abundant precedent in the field of contest broadcasts that would enable the designers of a single-round contest to set an appropriate cost or barrier to refine the resulting vote pool to a pool of nodes with an average level of influence greater than a random sample of equal size.

Step 30 is to electronically tabulate the votes using one or more computing devices, both in order to determine the outcome of the vote and to identify the nodes from which the votes have been cast. In the case of a multi-round contest, the vote is tabulated for each particular round. This may involve standard vote tabulating equipment and methods that are well-known to those skilled in the art. Steps 10 and 20 may be repeated multiple times over a number of days or weeks, with each broadcast presenting a different set of choices. In addition, at any particular round or stage in a contest, the outcome of the contest may, at least in part, be determined based on criteria other than audience votes, with contests that utilize different methods for determining the outcome of a contest still falling within the scope of the invention so long as votes are involved at some point in the contest.

In the embodiment of a multi-round contest or poll, the number of rounds is arbitrary, and can range from two to an arbitrary upper limit determined by the amount of time to be devoted to the contest, the number of contestants, the size of the audience, and possibly other factors. The embodiment of a single-round contest of course has just one round.

It will be appreciated that the tabulation and identification of votes is actually a tabulation and identification of individual voters by means of a telephone number, IP address, e-mail address, social media profile, or any other identifier associated, permanently or temporarily, with an individual voter. Identification of influential nodes enables marketers to offer attractive deals to fewer but more influential customers in order to effect the greatest increase in market share.

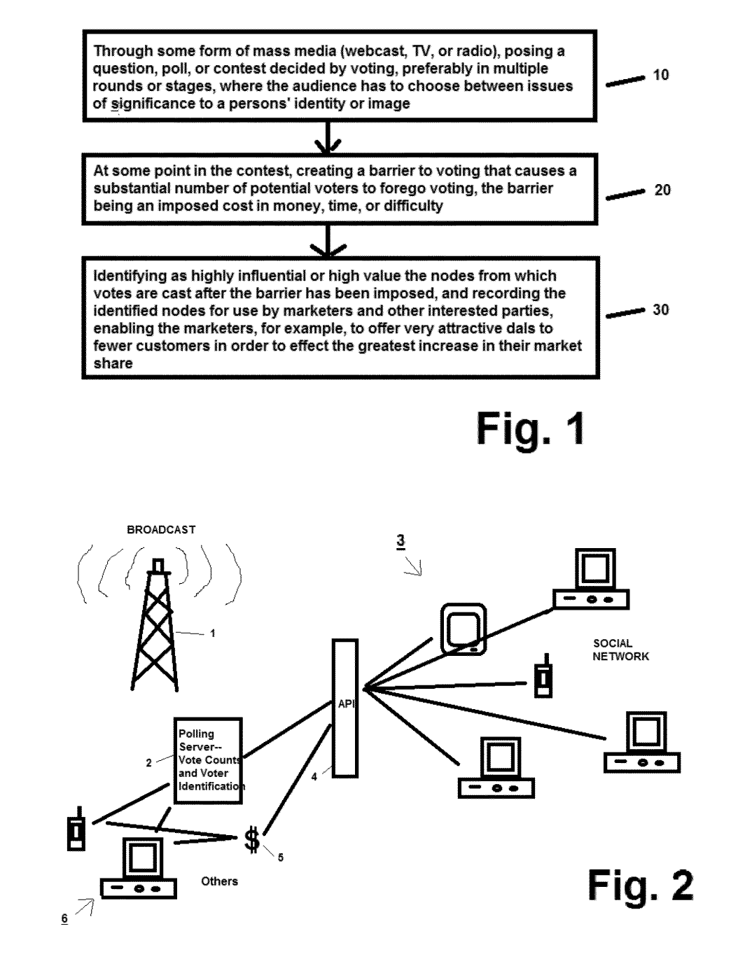

As shown in FIG. 2, the method of the invention is applied to a system that includes a broadcast source 1, which may be a static webpage, a webcast, a television or radio broadcast, or any other broadcast source; one or more servers or computing devices 2 for tabulating electronically-cast votes and identifying nodes; and computing devices 3 on a social network through which votes are cast and that communicate with the polling servers or computing device 2 through applications provided through an application programming interface 4 or the like.

The broadcast source 1 may be in the form of a webcast, a transmission over a traditional broadcast medium such as radio, television, or a cable network, a static webpage, or may utilize a combination of media. The broadcasts may occur at specified times, or be available on demand for an extended period. In addition, while music videos are provided as an example, the broadcast may also include live performances before an audience, scenes from films, and any other items significant to group identity.

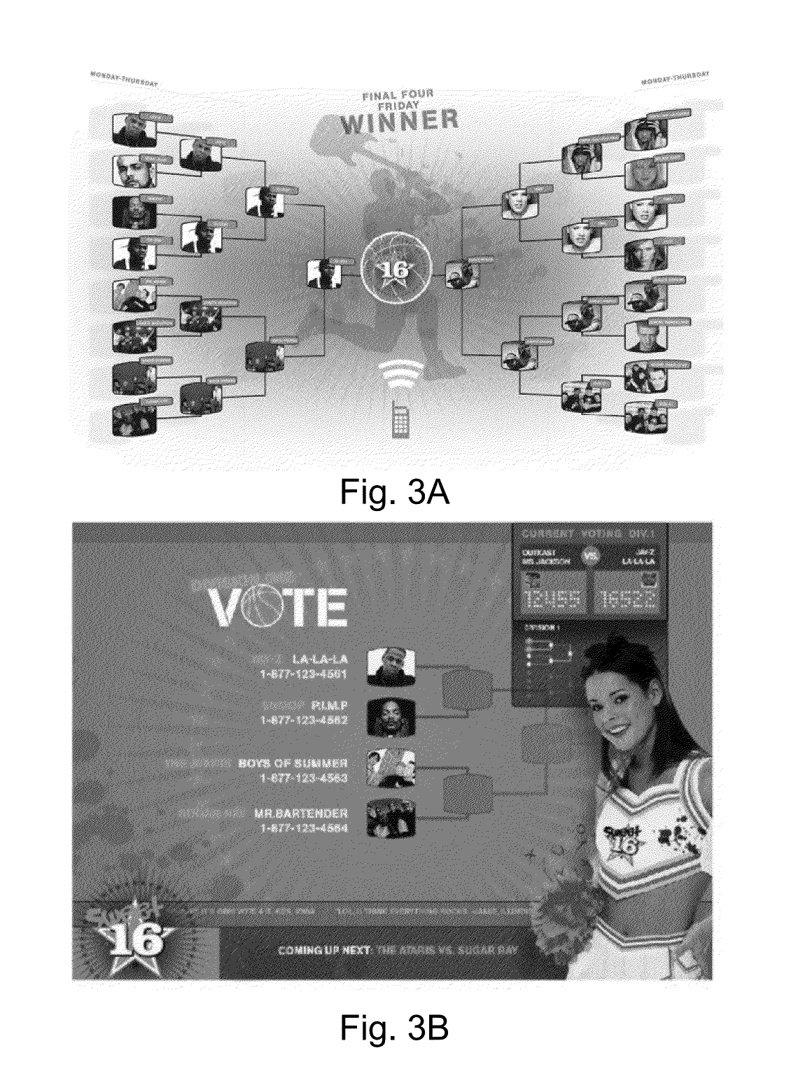

FIGS. 3A and 3B show an example of a type of contest to which the method of the invention may be applied. The contest is a music video ranking contest broadcast by television, with FIG. 3A illustrating the layout of the contest and FIG. 3B showing an invitation to vote by text messaging, with the outcome of the vote determining which videos move on to the next round. In this example, the cost of voting could be increased by increasing text message charges as the contest proceeds.

This type of contest takes advantage of the fact that musical taste is important to the group identity of members of an important demographic, namely young people, many of whom are likely to vote even if the cost of voting would deter most. As noted above, however, the contest is not limited to music, or other types of performing arts, but may also include sports, and may even involve current events about which viewers may wish to express their opinions in the form of polls or votes. In other words, the broadcast system is not part of the current invention, and the invention is not limited to a particular type of contest or broadcast, but only requires (a) that some sort of contest occur, and that the contest be broadcast over an electronic medium for presentation to viewers so that voting can occur, (b) that a significant cost of voting be established in order to create a barrier to voting, and (c) that the source of votes cast can be identified in order to identify a pool of nodes with greater influence than a random sample of the viewing audience.

Having thus described a preferred embodiment of the invention in sufficient detail to enable those skilled in the art to make and use the invention, it will nevertheless be appreciated that numerous variations and modifications of the illustrated embodiment may be made without departing from the spirit of the invention, and it is intended that the invention not be limited by the above description or accompanying drawings, but that it be defined solely in accordance with the appended claims.

What is claimed is:

1. A method of finding influential nodes of a social network, comprising the steps of:
in association with a broadcast or electronic display of a contest whose outcome is determined by votes from an audience of the broadcast, inviting members of the audience to cast votes in said contest by using electronic communications, the votes being affected by issues relevant to group identity;
setting a barrier to voting cost high enough to limit a number of voters or imposing a voting cost for a later round of voting that is higher than a voting cost of an earlier vote, said higher cost causing a number of voters in said later vote to decrease substantially relative to a number of voters in said earlier vote;
electronically receiving and tabulating said votes cast in said later vote to identify nodes from which said votes are cast, whereby said nodes have a greater mean average level of influence than an equal size random sample by virtue of having cast votes despite the barrier or cost and are therefore deemed to be nodes of greater influence.

2. A method of identifying influential nodes as claimed in claim 1, wherein said contest is a single round contest.

3. A method of identifying influential nodes as claimed in claim 1, wherein said contest is a multi-round contest.

4. A method of identifying influential nodes as claimed in claim 3, wherein a cost of voting is initially set low to attract a larger number of voters, and then increased after the first round of said multi-round contest.

5. A method of identifying influential nodes as claimed in claim 1, wherein said electronic means for casting votes includes casting votes by SMS message.

6. A method of identifying influential nodes as claimed in claim 1, wherein said electronic means for casting votes includes casting votes over the Internet via an application run on said social network.

7. A method of identifying influential nodes as claimed in claim 1, wherein said broadcast is a broadcast of a music competition, said votes being cast for contestants in said competition.

8. A method of identifying influential nodes as claimed in claim 1, wherein said electronic communications by which votes are cast includes multiple different communications media.
